(19) United States
(12) Patent Application Publication
(10) Pub. No.: US 2008/0238877 A1
(43) Pub. Date: Oct. 2, 2008

(54) PORTABLE INFORMATION DEVICE

(75) Inventor: Makoto Fujimoto, Takarazuka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 12/058,963

(22) Filed: Mar. 31, 2008

(30) Foreign Application Priority Data
Mar. 30, 2007 (JP) 2007-090760

(51) Int. Cl. G06F 3/02

(52) U.S. Cl. 345/169

(57) ABSTRACT

The present invention provides a portable information device including a display for displaying information, a key input unit having a plurality of keys to which numbers are assigned, a key input receiver for receiving an input of a key of the key input unit, a first detector for detecting contact of an object and the contact position, a second detector for detecting a change in the contact position detected by the first detector, and a display controller for controlling scrolling of a screen of the display, when the key input receiver receives an input of a key and the second detector detects a change in the contact position, on the basis of the number assigned to the received key and the change in the contact position.

The priority application Number 2007-090760 upon which this patent application is based is hereby incorporated by reference.

### BACKGROUND OF THE INVENTION

1. Field of the Invention

The present invention relates to portable information devices such as portable telephones, in particular, to portable information devices capable of displaying information such as electronic mails and websites, for example.

2. Description of Related Art

Conventional portable information devices such as portable telephones, for example, are provided with keys such as a ten key used in inputting letters and numbers and a power key for powering the device on/off, as well as a cross key (also called a multifunction key) to which upward, downward, rightward and leftward directions are assigned and which is depressed for selection of an item in a menu or for movement of the cursor on letter input. A user can move the cursor or scroll a screen by depressing the cross key.

However, the cursor movement and screen scrolling with the cross key is limited to movement in upward, downward, rightward and leftward directions. In addition, the amount of movement is predetermined so that depressing the cross key once corresponds to movement by one item in the menu or one line in the text of a mail, for example. Thus, when the user desires a large amount of movement, the user needs to depress the cross key many times, which is troublesome and takes time.

Accordingly, there has been proposed arranging a touch sensor over a ten key for detecting finger touch, and selecting an item in a menu or scrolling a screen on the basis of the direction, amount and track of movement of the finger over the touch sensor.

Such a conventional portable information device allows for the cursor movement and screen scrolling not only in upward, downward, rightward and leftward directions but also in an oblique direction. In this case, the amounts of movement of the cursor and scrolling of the screen vary depending on the amount of movement of the user's finger. Specifically, a small amount of movement of the finger makes a small amount of movement of the cursor or scrolling of the screen, and a large amount of movement of the finger makes a large amount of movement of the cursor or scrolling of the screen. However, even in such a case, a received mail with very long contents, which will be displayed over pages, would require the operation of repeatedly sliding a finger across the ten key, which is troublesome and takes time.

### SUMMARY OF THE INVENTION

The present invention provides a portable information device including a display for displaying information, a key input unit having a plurality of keys to which numbers are assigned, a key input receiver for receiving an input of a key of the key input unit, a first detector for detecting contact of an object and the contact position, a second detector for detecting a change in the contact position detected by the first detector, and a display controller for controlling scrolling of a screen of the display, when the key input receiver receives an input of a key and the second detector detects a change in the contact position, on the basis of the number assigned to the received key and the change in the contact position.

The portable information device of the present invention involves depressing a key to which a number is assigned and sliding a finger over a touch sensor, thereby allowing for the cursor movement or screen scrolling on the basis of the finger sliding direction and the depressed numeric key.

### BRIEF DESCRIPTION OF THE DRAWINGS

FIG. 1(a) is a front view showing a portable telephone in an open state;

FIG. 1(b) is a back view showing the portable telephone in the open state;

FIG. 2 is a function configuration diagram showing a function configuration of a portable telephone in a first embodiment;

FIG. 3 is a function block diagram showing the function configuration of the portable telephone in the first embodiment;

FIG. 4 is a flowchart showing a part of an operation of a CPU applied to the first embodiment;

FIG. 5 is a flowchart showing an example of scrolling processing applied to the first embodiment;

FIG. 6 is a flowchart showing an example of scrolling processing applied to a second embodiment; and

FIG. 7 is a flowchart showing an example of scrolling processing applied to a third embodiment.

### DETAILED DESCRIPTION OF THE INVENTION

### First Embodiment

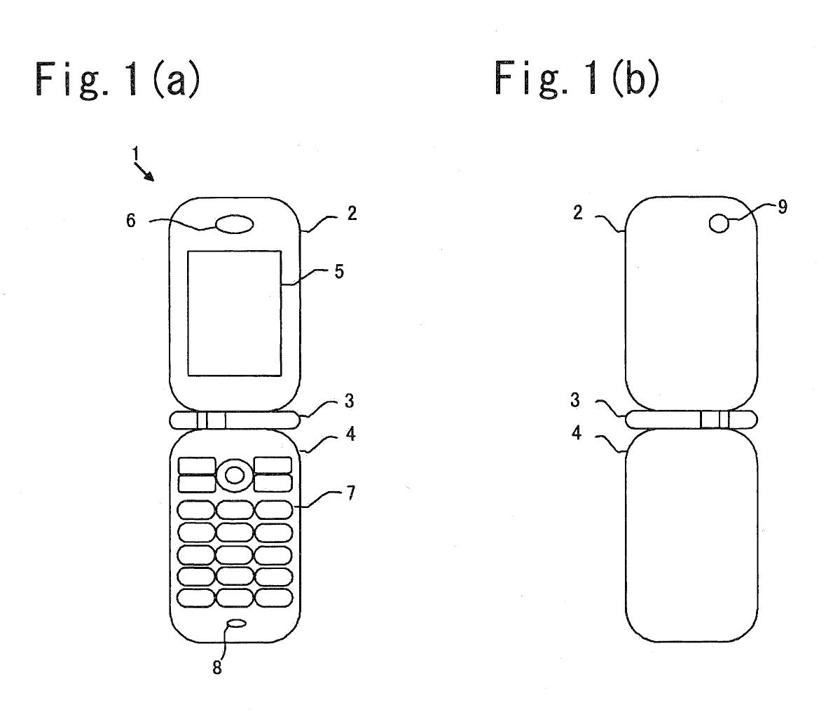

A first embodiment of the present invention is described with reference to FIG. 1 to FIG. 5.

FIG. 1(a) and FIG. 1(b) show an example of an appearance of a portable telephone 1 of an embodiment of the present invention. The portable telephone 1 has an upper housing 2 and a lower housing 4 coupled with a hinge part 3. The upper housing 2 has a display 5, a loudspeaker 6, and a camera device 9. The lower housing 4 has an operation part 7 provided with a plurality of keys and a microphone 8.

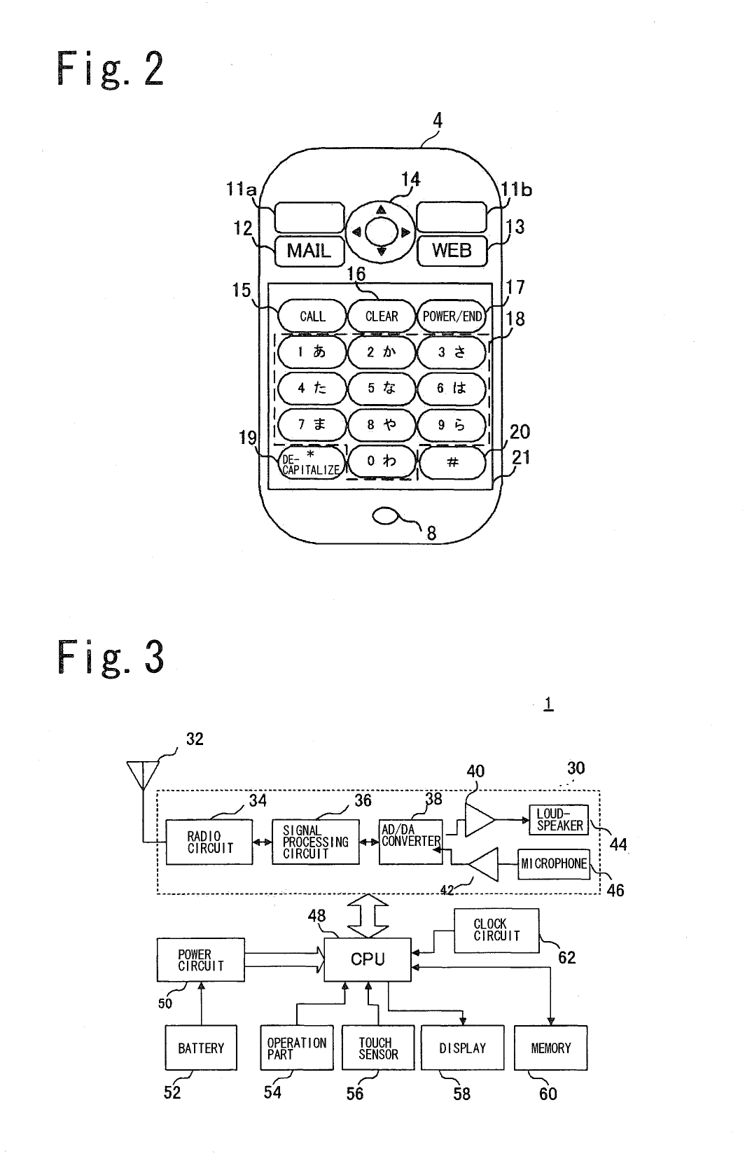

FIG. 2 is an enlarged appearance of the lower housing 4 shown in FIG. 1(a) and FIG. 1(b). The operation part 7 shown in FIG. 2 is provided with soft keys 11a and 11b, a mail key 12 for starting a mail function, a web key 13 for starting a web function, a cross key 14 to which upward, downward, rightward and leftward directions are assigned and which is for giving instructions for movement of the cursor or scrolling of the display, a call key 15 for dialing (calling) or answering incoming calls (off-hook), a clear key 16 for erasing letters input in a letter input mode or returning the screen to the last one, a power key 17 for ending the call and for powering the device on/off, a ten key 18 as a key input unit to which numbers of 0-9 and letters (Hiragana, Japanese characters, and alphabets) are assigned and which is for inputting these characters, a * key 19 and a # key 20.

A touch sensor 21 for detecting a contact position when touched by an object such as a finger or pen is provided surrounding the ten key 18, * key 19 and # key 20. The touch sensor 21 may use any method capable of detecting a contact position of a finger or pen, such as a capacitive sensing method or pressure sensing method.

FIG. 3 shows a block diagram of the portable telephone 1 of the first embodiment. The portable telephone 1 has a radio communication circuit 30, a CPU 48, a power circuit 50, a battery 52, an operation part 54, a touch sensor 56, a display 58, a memory 60, and a clock circuit 62. The radio communication circuit 30 includes an antenna 32, a radio circuit 34, a signal processing circuit 36, an AD/DA converting circuit 38, amplifiers 40, 42, a loudspeaker 44 and a microphone 46.

The portable telephone 1 connects by radio with a base station and receives voice data with the antenna 32. The received voice data is demodulated by the radio circuit 34, and thereafter given signal processing by the signal processing circuit. The voice data that has been given signal processing is converted by the AD/DA converting circuit 38 to a voice signal, which is an analog signal. The converted voice signal goes through the amp 40, and is output from the loudspeaker 44.

When a user of the portable telephone 1 speaks to the microphone 46, a voice signal goes through the amp 42, and is converted by the AD/DA converting circuit 38 to voice data, which is a digital signal. The signal processing circuit 36 encodes the converted voice data. The radio circuit 34 modulates the voice data output from the signal processing circuit 36. The modulated voice data is then transmitted from the antenna 32.

The CPU 48 has a function to control each element of the portable telephone 1. The power circuit 50 supplies power from the battery 52 to each element of the portable telephone 1. A lithium-ion battery or other various types of batteries may be used as the battery 52.

The operation part 54 receives a user operation, and outputs the received user operation to the CPU 48. The operation part 54 includes the above-described soft keys 11a and 11b, mail key 12, web key 13, cross key 14, call key 15, clear key 16, power key 17, ten key 18, * key 19 and # key 20.

The touch sensor 56 is provided on an area of a part of the operation part 54, and outputs to the CPU 48 contact of a dielectric such as a user's finger and the contact position coordinate. Each key of the operation part 54 and the touch sensor 56 have well known configurations.

The display 58 displays information indicated by the CPU 48. Specifically, it displays menu screens, mails, web information, still/moving images taken with the camera 9 and the like. An LCD (Liquid Crystal Display), an organic EL (Electroluminescence) display or the like is used.

The memory 60 stores programs and various applications executed by the CPU 48 for controlling the portable telephone 1, still/moving images, music data and the like. The memory 60 may be any type that stores information. A ROM (Read Only Memory), RAM (Random Access Memory), nonvolatile memory, hard disk or the like is used. The clock circuit 62 has a function to manage the current time. Further, it has a role of a timer function to time a predetermined time period.

The portable telephone 1 of the first embodiment can transmit and receive electronic mails (referred to as mails) besides voice data. When a mail is transmitted, the user prepares the mail with the operation part 54 while viewing the display, and gives instructions for transmission. Upon reception of the instructions for transmission from the user, the CPU 48 gives the mail data to the signal processing circuit 36. The mail data is given encoding processing by the signal processing circuit 36 and modulation processing by the radio circuit 34, and transmitted from the antenna 32.

When mail data is received from a base station via the antenna 32, the received mail data is given demodulation processing by the radio circuit 34 and decoding processing by the signal processing circuit 36, and output to the CPU 48. The CPU 48 stores the mail data to the memory 60.

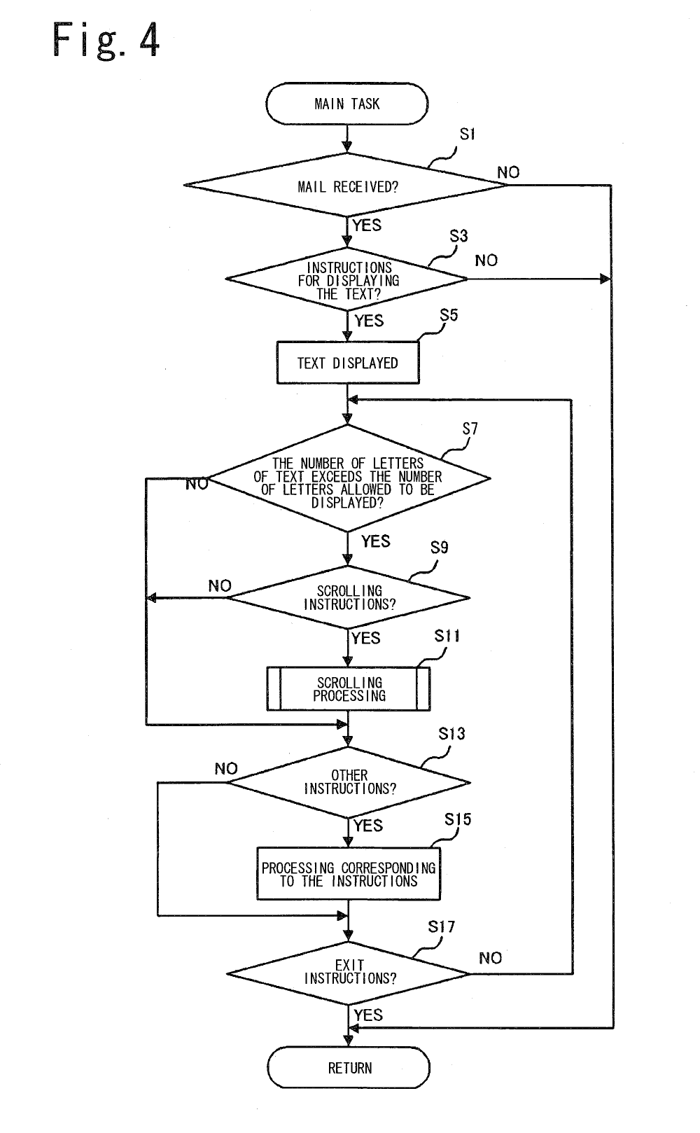

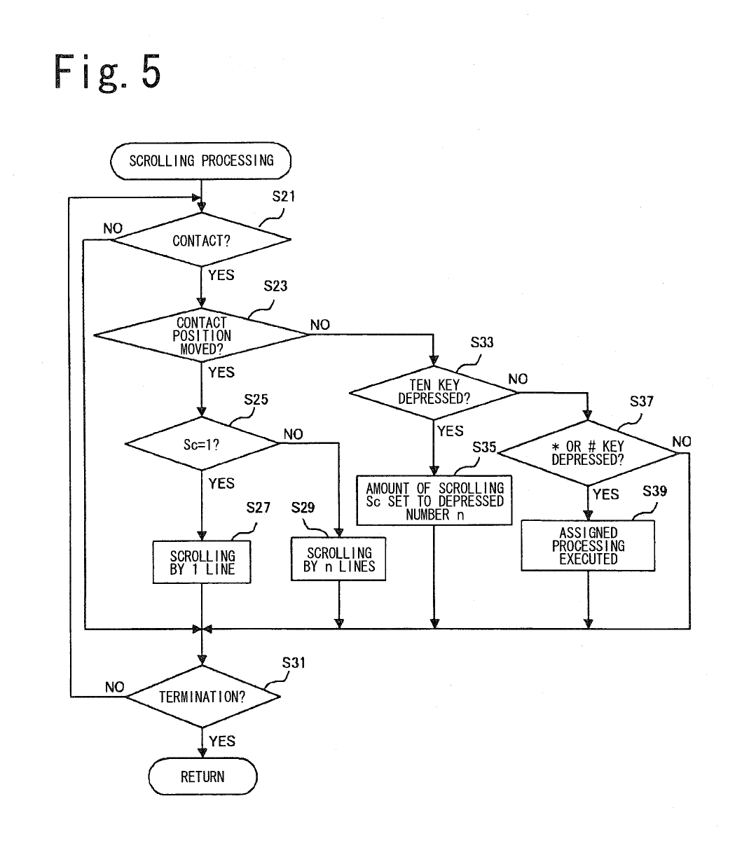

The mail data stored to the memory 60 can be displayed on the display 58 by the user operating the operation part 54 in accordance with a flow diagram shown in FIG. 4. The user can scroll the screen by operating the operation part 54 in accordance with a flow diagram shown in FIG. 5.

A processing operation of the CPU 48 of the portable telephone 1 in the first embodiment is described using the flowchart shown in FIG. 4. In step S1, it is determined whether a mail is received. If no, an upper layer routine, for example, standby display processing is performed. If yes, step S3 follows to determine whether instructions for displaying the text are given by the operation part 54. If no, the processing returns to the upper layer as in the case of no in step S1. If yes, step S5 follows.

In step S5, the CPU 48 permits the text to be displayed on the display 58. In step S7, it is determined whether or not the number of letters of the text to be displayed exceeds the number of letters allowed to be displayed in one screen of the display 58. If no, step S13 follows. If yes here, it is determined that the letters not displayed cannot be displayed unless the screen is scrolled.

In step S9, it is determined whether or not the user has given scrolling instructions. If no, step S13 follows. If yes, the CPU 48 proceeds to step S11 to perform scrolling processing. Details of the scrolling processing will be described later using FIG. 5.

In step S13, it is determined whether or not the user has given other instructions than scrolling instructions. Other instructions here are, for example, depressing the soft key 11a, to which a menu “reply” is assigned.

If no in step S13, step S17 follows. If yes, the CPU 48 performs processing as instructed. If the instructions “reply” are given as described above, it performs processing to change the screen to one to prepare a reply mail to the sender of the mail. In step 17, it is determined whether or not the user has given instructions to exit the display of the mail text. If no, the processing returns to step S7. If yes, it ends.

The scrolling processing of step S11 of FIG. 4 is executed when scrolling instructions are given in step S9 of FIG. 4. For scrolling instructions, for example, the user depresses the “2” key of the ten key, and then takes the finger off the operation part 54. The user then touches the “2” key of the ten key again, and slides the finger to the “5” key and then “8” key of the ten key. The scrolling processing is executed when an operation is performed for which a downward change in the contact position relative to the touch sensor 21 is detected provided that the hinge part 3 is the top.

On the basis of this example, the scrolling processing of step S11 of FIG. 4 is now described with reference to FIG. 5. In step S21 of FIG. 5, the CPU 48 determines whether or not the touch sensor 56 is touched by a finger. If it is not touched by a finger, the answer is no and step S31 follows. If the ten key “2” is depressed as in the above example, the answer in step S21 is yes and step S23 follows.

In step S23, it is determined whether or not the position coordinate touched by the finger has changed. Here the finger touches the “2” key but does not move, and therefore no is determined and step S33 follows. In step S33, it is determined whether or not any of the ten key is depressed. If the finger of the user touches the operation part 54 but does not change the touched position, nor is any ten key depressed, then no is determined and step S37 follows. In this example, the “2” key is depressed, and therefore yes is determined in step S33 and step S35 follows. In step S35, the amount of scrolling is updated from the default of Sc=1 to Sc=n on the basis of the number n of the depressed ten key. The Sc represents the amount of scrolling, with the default being Sc=1. In the case of Sc=1, it is defined that one scrolling instruction corresponds to scrolling by one line.

In step S35, since the “2” key has been depressed, it is defined that one scrolling instruction corresponds to scrolling by two lines, and the amount of scrolling Sc is set from Sc=1 to Sc=2. Then step 31 follows. In step S37, it is determined whether or not the * key or # key is depressed. If no, step S31 follows. If yes, step S39 follows.

In step S39, processing assigned to each key is performed, and then step S31 follows. The processing assigned to the keys in step S39 may be, for example, the user depressing the * key to thereby cause the CPU 48 to display a smaller character size, and depressing the # key to thereby display a larger character size.

In step S31, it is determined whether termination instructions are given. The termination instructions here may be depression of the end key or the other instructions of step S13 of FIG. 4. In the above example, the user depresses the “2” key and thereafter slides the finger to the “5” key and then “8” key, and therefore no is determined in step S31 and the processing returns to step S21. Next in step S21, yes is determined and step S23 follows.

In step S23, yes is determined because the finger of the user has moved from the “2”→“5”→“8” key, and then step S25 follows. In step S25, it is determined whether or not the amount of scrolling Sc is Sc=1. If yes, step S27 follows to scroll the screen downward by one line, and then step S31 follows. Here, since Sc=1 has been updated to Sc=2, no is determined in step S25 and then step S29 follows.

In step S29, since Sc=2 has been stored, the screen is scrolled downward by two lines, and then step S31 follows. If it is determined that termination instructions are given in step S31, then the answer is yes and the scrolling processing terminates.

As above, the portable telephone 1 of the first embodiment of the present invention sets the amount of scrolling Sc to the number n of the ten key depressed by the user. The displayed screen is scrolled by the set amount of Sc=n on the basis of the change in the position of the operation part 54 in contact with the user's finger. This allows the user to set the amount of scrolling at one time to a desired one by depression of a ten key when the user reads a mail with a long text. The user can then easily scroll the screen by sliding a finger over the operation part 54 in a desired direction without depressing a key.

### Second Embodiment

In the above described first embodiment, the user depresses the “2” key of the ten key. The user then takes the finger off the operation part 54, touches the “2” key of the ten key again, and slides the finger to the “5” key and then “8” key of the ten key. In contrast, in the second embodiment, the user depresses the “2” key of the ten key. The user maintains the contact without taking the finger off the operation part 54, and then slides the finger to the “5” key and then “8” key of the ten key. Only this operation allows for scrolling processing with the amount of scrolling Sc being the number n of the ten key.

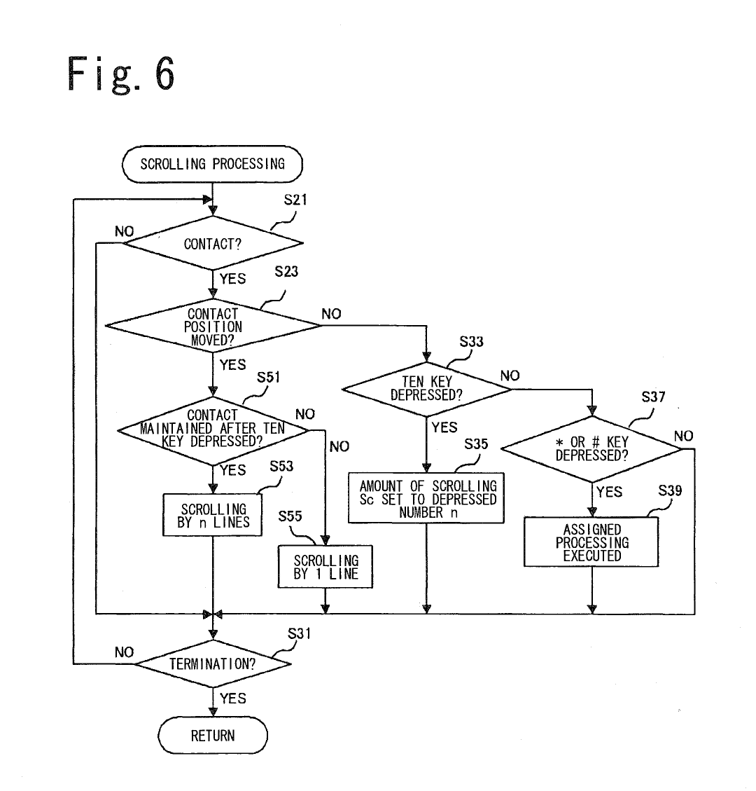

The appearance of the portable telephone 1 in the second embodiment is the same as that of FIG. 1, and therefore not described. The flow before scrolling processing, including receiving a mail and displaying it, is also the same as the flow diagram of FIG. 4 in the first embodiment, and therefore not described. The second embodiment is described with reference to FIG. 6. This differs from the flow of FIG. 5 of the first embodiment in that step S51 follows if yes is determined in step S23, followed by step S53 or step S55. FIG. 6 is the same as FIG. 5 in other respects than steps S51-S55. Accordingly, only steps S51-S55 are described here.

When the user depresses the “2” key, maintains the contact with the operation part 54, and then slides the finger from “2”→“5”→“8” as in the above example, yes is determined in step S23 because the finger of the user has moved from “2” to “8”. In step S51, no is determined if the user takes the finger off the operation part 54 after depressing the “2” key, and step S55 follows. Yes is determined if the finger maintains the contact with the operation part 54, and step S53 follows. In this example, yes is determined because the user has depressed the “2” key of the ten key, maintained the contact with the operation part 54, and then slid the finger from “2”→“8”.

In step S53, the display is scrolled downward by two lines because the amount of scrolling is set to Sc=2. In step S55, the amount of scrolling Sc=2 is set to the default of Sc=1, and then the display is scrolled downward by one line.

As above, the portable telephone 1 of the second embodiment of the present invention has the same advantage as in the first embodiment. Further, when the user depresses a ten key, maintains the contact with the operation part 54, and then slides the finger, the amount of scrolling Sc is set to the number n of the depressed ten key. The displayed screen is scrolled by the set amount of Sc=n on the basis of the change in the position of the operation part 54 in contact with the user's finger. When the user depresses a ten key and then takes the finger off the operation part 54, the amount of scrolling is set to the default of Sc=1. This allows the amount of scrolling to be easily reset to the default.

### Third Embodiment

In the above described first embodiment, the user depresses the “2” key of the ten key. The user then takes the finger off the operation part 54, touches the “2” key of the ten key again, and slides the finger to the “5” key and then “8” key of the ten key. In contrast, in the third embodiment, the user depresses the “2” key of the ten key, and then slides the finger over the ten key within a predetermined time. Only this operation allows for scrolling processing with the amount of scrolling Sc being the number n of the ten key.

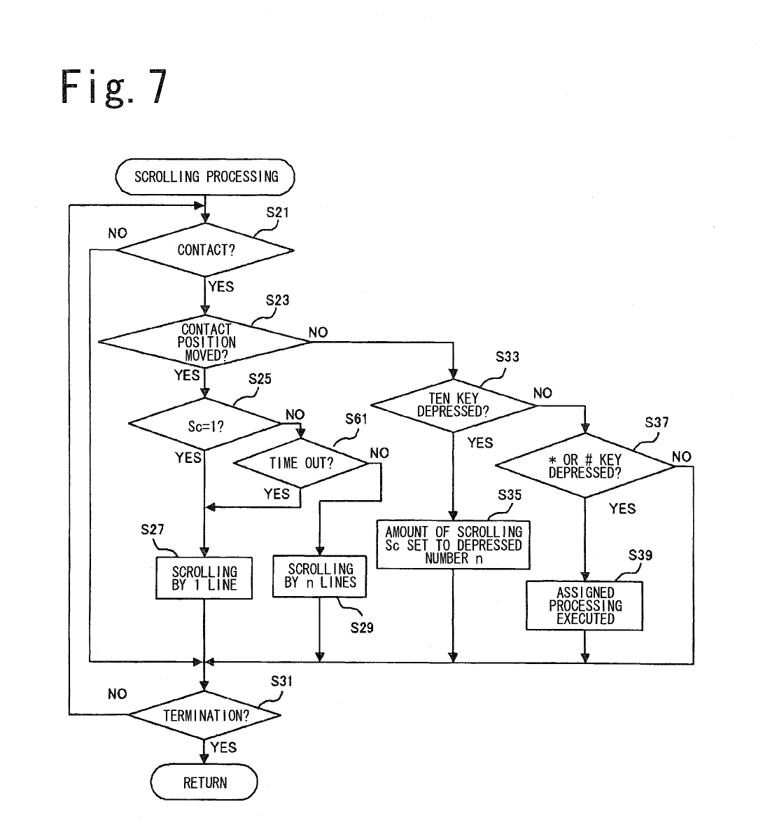

The appearance of the portable telephone 1 in the third embodiment is the same as that of FIG. 1, and therefore not described here. The flow before scrolling processing, including receiving a mail and displaying it, is also the same as the flow diagram of FIG. 4 in the first embodiment, and therefore not described. The third embodiment is described with reference to FIG. 7. This differs from the flow of FIG. 5 of the first embodiment in that step S61 follows if no is determined in step S25. FIG. 7 is the same as FIG. 5 in other respects than step S61. Accordingly, only step S61 is described here.

When the user depresses the “2” key and then slides the finger from “2”→“5”→“8” of the ten key within a predetermined time as in the above example, step S25 is followed by step S61 because the amount of scrolling is set to Sc=2. In step S61, it is determined whether a predetermined time has elapsed from the depression of the ten key until the detection of the movement of the contact position. Step S27 follows if the predetermined time is exceeded and yes is determined. In step S27, even though the amount of scrolling is set to Sc=2, it is reset to the default of Sc=1, and the display is scrolled downward by one line. If no is determined in step S61, then step S29 follows. In step S29, the display is scrolled downward by two lines because the amount of scrolling is set to Sc=2.

The above example of the third embodiment is characterized in that it is determined whether or not the user has slid the finger over the operation part 54 within a predetermined time after depressing a ten key. In the third embodiment, when the user repeats the finger sliding operation within a predetermined time, the display may be scrolled with the unchanged setting of the amount of scrolling Sc=n.

As above, the portable telephone 1 of the third embodiment of the present invention has the same advantage as in the first embodiment. Further, when the user depresses a ten key and thereafter slides the finger over the operation part 54 within a predetermined time, the amount of scrolling Sc is set to the number n of the depressed ten key. The displayed screen is scrolled on the basis of the change in the position of the operation part 54 in contact with the user's finger. When the user depresses a ten key and then slides the finger over the operation part 54 after a predetermined time is exceeded, the amount of scrolling is set to the default of Sc=1. This allows the amount of scrolling to be easily reset to the default.

The portable telephone 1 of the first to third embodiments of the present invention may be configured so that the display continues to be scrolled without the finger sliding operation by depressing a predetermined key, for example, the “0” key of the ten key after the finger sliding operation over the operation part 54. This eliminates the necessity of repeatedly sliding the finger over the operation part 54, allowing the user to scroll the display by n lines with the amount of scrolling being Sc=n.

When the display is scrolled by n lines, the user may depress a ten key m to thereby set the amount of scrolling to Sc=m. This allows the user to change the amount of scrolling to a desired one when the display is scrolled by n lines and continue scrolling of the display.

In the above described embodiments, the amount of scrolling is described on the basis of the line. However, the amount of scrolling may be on the basis of the screen displayed on the display at one time. The above described embodiments are described on the basis of scrolling of the display, but the invention may be applied to movement of the cursor.

In the above described embodiments, the touch sensor 21 for detecting the contact position when touched by an object such as a finger or pen is provided not exclusively surrounding the ten key 18, * key 19 and # key 20, and may be provided on any location of the portable telephone 1.

While in the embodiments scrolling of a screen of the display is described, the present invention can control operations of various functions on the basis of depression of a ten key and the detection result of the touch sensor 21. For example, the invention can be applied to fast forward, rewind, frame advance and the like of a media player that reproduces music data and moving image data. Specifically, when music data is reproduced, the user slides the finger from “4”→“5”→“6” of the ten key of the operation part 54 for fast forward. The user can set the fast forward speed Fs=1 to Fs=4 for fast forward by depressing the “4” key and thereafter sliding the finger from “4”→“5”“→6”.

The above described second and third embodiments can also be applied to fast forward, rewind, frame advance and the like of a media player that reproduces music data and moving image data.

What is claimed is:

1. A portable information device comprising:
a display for displaying information;
a key input unit having a plurality of keys to which numbers are assigned;
a key input receiver for receiving an input of a key of the key input unit;
a first detector for detecting contact of an object and the contact position;
a second detector for detecting a change in the contact position detected by the first detector; and
a display controller for controlling scrolling of a screen of the display, when the key input receiver receives an input of a key and the second detector detects a change in the contact position, on the basis of the number assigned to the received key and the change in the contact position.

2. The portable information device according to claim 1, wherein the display controller defines the direction of the change in the contact position as the scrolling direction of the screen.

3. The portable information device according to claim 1, wherein the display controller defines the number assigned to the key as the amount of scrolling of the screen.

4. The portable information device according to claim 3, wherein the display displays information by the line, and the amount of scrolling is the number of lines.

5. The portable information device according to claim 3, wherein the display displays information allowed to be displayed at one time by the screen, and the amount of scrolling is the number of screens.

6. The portable information device according to claim 1, wherein the display controller controls scrolling of a screen of the display when the first detector detects contact between after the key input receiver receives an input of a key until the second detector detects a change in the position.

7. The portable information device according to claim 1, wherein the display controller continues to control scrolling when the second detector detects a change in the contact position and a predetermined key is depressed.

8. The portable information device according to claim 1, wherein the display controller controls scrolling of a screen of the display, when a change in the contact position is detected within a predetermined time after the key input receiver receives an input of a key, on the basis of the number assigned to the received key and the change in the contact position.

9. A portable information device comprising:
a reproducer for reproducing information;
a key input unit having a plurality of keys to which numbers are assigned;
a key input receiver for receiving an input of a key of the key input unit;
a first detector for detecting contact of an object and the contact position;
a second detector for detecting a change in the contact position detected by the first detector; and
a reproduction controller for controlling reproduction of the reproducer, when the key input receiver receives an input of a key and the second detector detects a change in the contact position, on the basis of the number assigned to the received key and the change in the contact position.

10. The portable information device according to claim 9, wherein the reproduction controller defines the number assigned to the key as the reproducing speed.
